(19) United States
(12) Patent Application Publication
(10) Pub. No.: US 2011/0147615 A1
(43) Pub. Date: Jun. 23, 2011

(54) Method and apparatus for microscopic imaging system with wide field of view and high collection efficiency

(76) Inventor: Gregory J. Kintz, Asheville, NC (US)

(21) Appl. No.: 12/974,887

(22) Filed: Dec. 21, 2010

Related U.S. Application Data
(60) Provisional application No. 61/289,824, filed on Dec. 23, 2009.

(51) Int. Cl. G02B 21/06; G01J 1/58

(52) U.S. Cl. 250/459.1; 359/385

(57) ABSTRACT

A microscopic imaging system using a laser excitation source, a scanner system, an optical relay system, a first focusing lens, a sample container and a detection system is used to examine tissue and other biological samples. The microscopic imaging system uses a relay optics and simplified compact object to produce a curved image plane in the sample and a method for transforming the curved image field into Cartesian coordinates is described. The system can incorporate a focus compensation system within the compact object to improve the imaging through the sample. The system can incorporate a sample chamber with integrated optics to improve the collection efficiency of the detection system in the microscopic imaging system. The system can incorporate a movable mirror with other fold mirrors to allow for multi-sided imaging of a sample.

### CROSS-REFERENCE TO RELATED APPLICATIONS

This application claims the benefit of U.S. Ser. No. 61/289,824 filed Dec. 23, 2009, which application is fully incorporated herein by reference.

### FIELD OF THE INVENTION

This invention relates generally to a system and its methods of use for performing microscopic imaging of samples using a simplified optical system using novel configurations of optics, and more particularly to a system and its methods of use for correcting field curvature in a sample though transformation of a stack of 2-d curved slices into a 3-d image.

### BACKGROUND

Microscopic imaging using light has been practiced for many years. The fundamental diffraction properties of light determine the resolution of a given optical microscopic imaging system. The numerical aperture that defined the cone angle of light near the focus together with the wavelength of the observation light determines the resolution of a given optical microscopic imaging system. The characterization of the resolution of a given optical microscopic imaging system is often performed by computing the Strehl Ratio, the ratio of a focused spot size to an ideal spot size limited by diffraction. The closer the Strehl Ratio is to unity, the closer the optical microscopic imaging system is a diffraction limited system. This analysis generally applies to all optical microscopic imaging systems.

The field of view of an optical microscopic imaging system is the area that a given optical microscopic imaging system exceeds a given value of resolution or by relation the Strehl ratio. Generally a larger field of view is desirable for most applications of optical microscopic imaging systems.

Optical microscopic imaging systems have been developed using scanned laser techniques. Confocal microscopy is a broader technique that uses a spatial filter to limit the light observed from a sample. Many confocal microscopes use scanned laser sources in conjunction with the spatial filter. Multi-photon microscopy use a scanned laser with a short pulse at a longer wavelength and signal light is generated at the focus of the scanned laser beam due to non-linear interactions with matter located at the focus. The non-linear interactions occurring at the focus can include second harmonic generation, two-photon absorption, three-photon absorption. If the two-photon absorption or three-photon absorption occurs in a fluorescent material, then two-photon or three-photon fluorescence occurs. Multi-photon microscopy has an advantage because the non-linear interactions only occur at the focus of the scanned laser beam. Generally, the shorter the laser pulse, the more non-linear interaction can occur, thus more signal light is generated. Some of the signal light is generated at the focus of the scanned laser beam has a preferred directionality for example second harmonic generation, while other of the signal light is generated at the focus of the scanned laser beam is emitted isotropically for example two-photon fluorescence and three-photon fluorescence. To improve the sensitivity of the multi-photon microscopic imaging systems, the collection of the entire isotropically emitted signal light is desirable.

Multi-photon microscopy uses short pulse lasers and the dispersion of the materials used in the optical microscopic imaging system can increase the duration of the pulse. The increase in pulse duration is related to the total optical path through the materials and the dispersion properties of the materials. The pulse duration increase is computed by the following formula.

τ=τ₀[1+(4 ln(2)Φ/τ₀²)²]^{1/2}

Where: τ=output pulse duration, τ₀=input pulse duration, and Φ=GDD. The Group Delay Dispersion (GDD) for the system is calculated using total optical path through the materials and the dispersion properties of the materials. For 100 fs input pulse, and a GDD of 1000 fs², the output pulse increase to 103.8 fs.

A pulse compressor is a device that is used to compensate for the increase in pulse duration caused by the dispersion of materials. Typical designs include grating or prism pairs. The pulse compressor is sensitive to alignment and introduces additional loss in the optical system. An optical system that minimizes the Group Delay Dispersion so that a pulse compressor is not needed is desirable.

Optical microscopic imaging systems have generally been used to observe a flat image field. The optical microscopic imaging systems generally have been used to image a sample on a microscope slide. There is a large body of art around the design of microscope objectives to produce a flat image field. Typically optical microscopic imaging systems cannot penetrate into a sample, thus imaging a flat sample mounted on a microscope slide has been the standard practice. Both confocal and multi-photon imaging have the ability to penetrate into a sample. Both the confocal and multi-photon imaging techniques have typically used a standard microscope objective with a flat image field. A flat field optical system design generally has a restricted field of view compared with an optical system design that is not constrained to a flat image field. The natural Petzval field curvature for a lens system must be overcome in a flat field optical system design.

There is a need for optical designs with a an image field that is curved, has a wide field of view and maintains a high resolution over the wide field of view. There is a further need for optical designs that minimize the number of components to minimize the effects of dispersion in a multi-photon imaging mode. There is a further need for optical systems that minimize the number of components to minimize the effects of dispersion in a multi-photon imaging mode. There is a further need for optical systems that can utilize movable mirrors to allow a sample to be imaged from a multiple of sides while minimizing the number of components. There is a further need for optical system designs utilize movable mirrors to allow a sample to be imaged from a multiple of sides while minimizing the number of components.

### SUMMARY OF THE INVENTION

Accordingly, an object of the present invention is to provide optical systems and their methods of use that work with the natural Petzval field curvature to produce an image field that is curved, has a wide field of view and maintains a high resolution over the wide field of view.

Another object of the present invention is to provide optical systems and their methods of use that transform a curved image field into Cartesian coordinates is described.

Yet another object of the present invention is to provide microscopic imaging systems, and their methods of use, that have a curved image field which can be used in either a multi-photon mode of detection or a confocal mode of detection.

A further object of the present invention is to provide optical systems and their methods of use that minimize the number of components to minimize the effects of dispersion in a multi-photon imaging mode.

These and other objects of the present invention are achieved in a microscopic imaging system that has a laser source and a scanner system coupled to the laser source. A first lens is coupled with the scanner system. The first lens produces a scanner laser spot with a curved field that is incident on a tissue site. A detection system detects a fluorescence and non-linear light emitted from the tissue site.

In another embodiment, a method is provided for examining tissue at a tissue site. A beam of light is produced from a laser source and scanned. A scanner laser spot is produced with a curved field that is incident on the tissue site, fluorescence and non-linear light emitted from the tissue site are detected.

### BRIEF DESCRIPTION OF THE DRAWINGS

FIG. 1 illustrates a schematic layout of the microscopic imaging system with a curved image field according to the present invention.

FIG. 2 illustrates a schematic layout of the microscopic imaging system with a curved image field and an integrated collection optic according to the present invention.

FIG. 3 illustrates a schematic layout of the microscopic imaging system operating in multiphoton mode according to the present invention.

FIG. 4 illustrates a schematic layout of the microscopic imaging system operating in confocal mode according to the present invention.

FIG. 5 illustrates the details of the curved field as a function of depth according to the present invention.

FIG. 6 illustrates a specific arrangement of the optical relay lenses and first focusing lens according to the present invention.

FIG. 7 illustrates a second specific arrangement of the optical relay lenses and first focusing lens according to the present invention.

FIG. 8 illustrates a third specific arrangement of the optical relay lenses and first focusing lens according to the present invention.

FIG. 9 illustrates a multi channel detection system integrated with the microscopic imaging system operating in multiphoton mode according to the present invention.

FIG. 10 illustrates a variable thickness cell focus compensation system according to the present invention.

FIG. 11 illustrates a sample chamber with integrated reflective optics together with a hollow waveguide according to the present invention.

FIGS. 12(a) and 12(b) illustrate a movable mirror imaging two orthogonal sides of the sample chamber according to the present invention.

FIGS. 13(a) and 13(b) illustrate a movable mirror imaging two opposing sides of the sample chamber according to the present invention.

FIG. 14 illustrates a movable mirror imaging four sides of the sample chamber according to the present invention.

FIG. 15 illustrates a movable mirror imaging two opposing sides of the sample chamber together with a desired arrangement of detection optics according to the present invention.

### DETAILED DESCRIPTION

The present invention provides a microscopic imaging system of the present invention, and its methods of use, with a minimal number of components. This reduces the system complexity and the need for additional components including but not limited to pulse compensators and the like. In one embodiment, as more fully explained below, the microscopic imaging system of the present invention includes a laser excitation source, a scanner system, an optical relay system, a first focusing lens, a sample container and a detection system. With the system of the present invention, tissue and other biological samples can be examined. The microscopic imaging system of the present invention has relay optics and a simplified first focusing lens to produce a curved image plane in the sample to be examined, as well as a method for transforming the curved image field into Cartesian coordinates. The microscopic imaging system can be used in either a multi-photon mode of detection or a confocal mode of detection. The selection of multi-photon mode or confocal mode affects the type of laser source and the type of detection system.

The present invention provide for imaging of a tissue sample rapidly is useful in a wide range of medical practices including inter-operative observation of tumor samples or biopsies. Imaging a tissue sample with wide field of view and at high resolution with high collection efficiency can improve the speed of the imaging of a tissue sample. Currently the prior art uses a process of tiling, moving the sample under the imaging system to a new location and taking another image, and the tiling process is repeated until the entire sample is covered. By imaging the tissue sample with wide field of view, a large (>0.5 mm²) sample without tiling and the speed of the imaging process is improved because the sample does not need to be moved.

Imaging the tissue sample with wide field of view and a high resolution eliminates the need for the precision translation stages needed to precisely move the sample to the new location. The prior art does teach the advantages of and method of improving the collection efficiency with either mirrors or fiber optics. Generally high collection efficient improves penetration depth and high collection efficient reduces excitation laser power requirements. Generally improving the collection efficiency improves the speed of the imaging process.

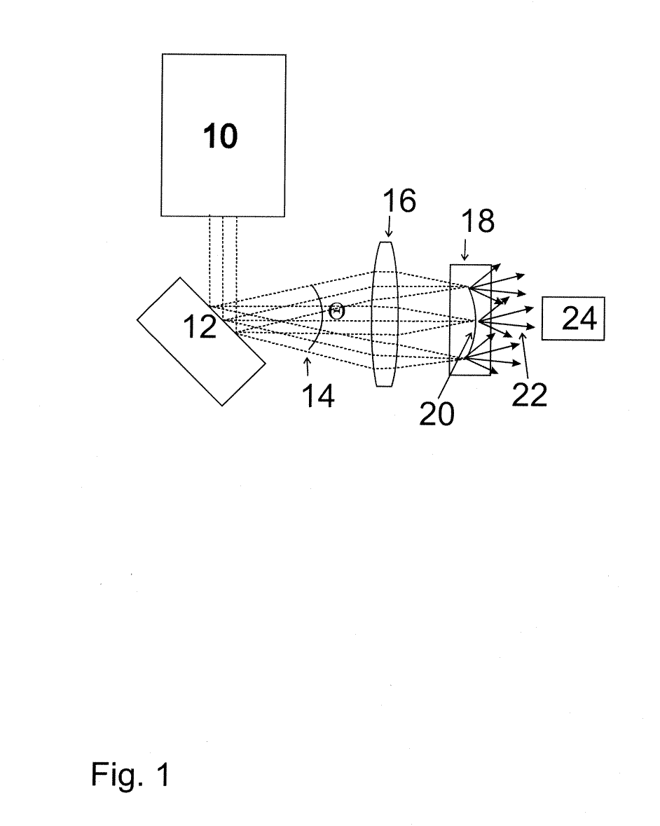

FIG. 1 schematically illustrates a microscopic imaging system operating in multiphoton mode according to the present invention. The system of the present invention can be comprised of a laser source 10 can be a ultra-fast laser system that produces a train of pulses that in one embodiment are less that 1 ps and in one embodiment is less than 150 fs. A scanner system 12 can be used to scan the laser light rays 14 from a laser over an angle Θ preferably in two orthogonal directions. The scanner system 12 can be a variety of technologies including but not limited to 2-axis MEM (Micro Electrical Mechanical) scanner, a pair of galvanometer scanners, a pair of galvanometer scanners with relay optics, holographic scanners, acousto-optic scanners, modulated fiber optic scanners, Grating based MEMs (Micro Electrical Mechanical) scanner systems; and light valve based scanners or a variety of other laser bean scanning technologies.

In one embodiment the scanner system 12 can be a 2-axis MEM (Micro Electrical Mechanical) scanner or a pair of galvanometer scanners with relay optics.

The laser light rays 14 travel to a first focusing lens 16 consist of one or more aspheric lenses that produce a scanned laser spot within a sample cell 18 with a curved image field 20 while maintaining a high Strehl Ratio over a wide field of view. The first focusing lens 16 is schematically shown as a single aspheric lens. The aspheric lenses can be formed using molded glass lens technology. The first focusing lens can also incorporate one or holographic or binary surfaces.

The radius of the curved image field 20 can change as a function of focus depth within the sample. The interaction of the laser light with the sample creates emitted signal light 22 from the sample. A detection system consists of a detector 24. The detector 24 measures the emitted signal light 22 from the sample.

In multiphoton mode because the emitted signal light 22 is no longer affected by the dispersion effect due to optical material thicknesses, a wide range of optical configurations can be used to collect the light. The signal light can be split into two or more channels by the use of dichroic beamsplitters and beamsplitters to determine the spectral content of the signal. Other technologies can be used to split the signal into different spectral components including gratings, holographic gratings, tunable liquid crystal filters and other wavelength selecting technologies. In one embodiment, the detector 24 has high sensitivity including but not limited to photo-multiplier tubes, silicon detectors, avalanche photo detectors and the like.

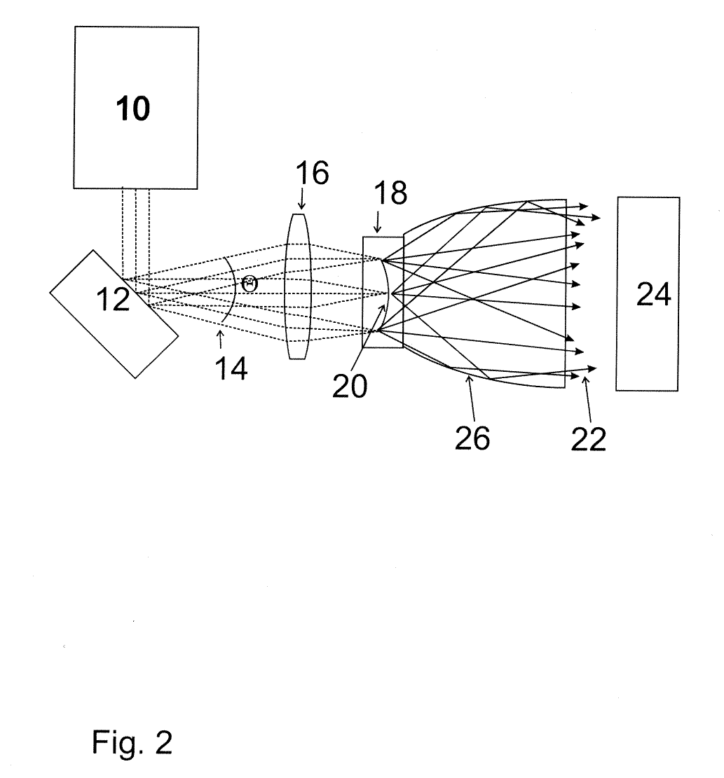

FIG. 2 schematically illustrates a microscopic imaging system operating in multiphoton mode according to the present invention. The system of the present invention can be comprised of a laser source 10 can be a ultra-fast laser system that produces a train of pulses that in one embodiment are less that 1 ps and in one embodiment is less than 150 fs. A scanner system 12 can be used to scan the laser light rays 14 from a laser over an angle Θ preferably in two orthogonal directions. The scanner system 12 can be a variety of technologies including but not limited to 2-axis MEM (Micro Electrical Mechanical) scanner, a pair of galvanometer scanners, a pair of galvanometer scanners with relay optics, holographic scanners, acousto-optic scanners, modulated fiber optic scanners, Grating based MEMs (Micro Electrical Mechanical) scanner systems; and light valve based scanners or a variety of other laser bean scanning technologies.

In one embodiment the scanner system 12 can be a 2-axis MEM (Micro Electrical Mechanical) scanner or a pair of galvanometer scanners with relay optics.

The laser light rays 14 travel to a first focusing lens 16 consist of one or more aspheric lenses that produce a scanned laser spot within a sample cell 18 with a curved image field 20 while maintaining a high Strehl Ratio over a wide field of view. The first focusing lens 16 is schematically shown as a single aspheric lens. The aspheric lenses can be formed using molded glass lens technology. The first focusing lens can also incorporate one or holographic or binary surfaces.

The radius of the curved image field 20 can change as a function of focus depth within the sample. The interaction of the laser light with the sample creates emitted signal light 22 from the sample. The emitted signal light 22 is collected by an integrated collection optic 26 that is shape like a solar concentrator. The integrated collection optic 26 collects the light by total internal reflection off the interior surfaces. A detection system consists of a detector 24. The detector 24 measures the emitted signal light 22 from the sample.

In multiphoton mode because the emitted signal light 22 is no longer affected by the dispersion effect due to optical material thicknesses, a wide range of integrated collection optic 26 configurations can be used to collect the light. The integrated collection optic 26 can be a collection of solid collectors shaped like solar concentrators. The integrated collection optic 26 can be incorporate other total internal reflecting structures, mirrors, or gratings to improve the overall collection of signal light 22.

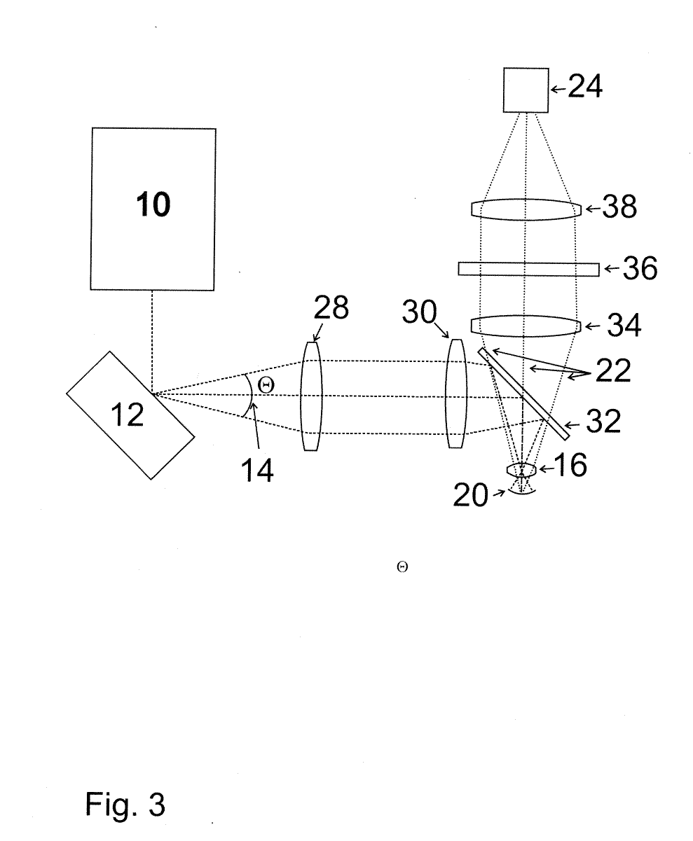

FIG. 3 schematically illustrates a microscopic imaging system operating in multiphoton mode according to the present invention. The system of the present invention can be comprised of a laser source 10 can be a ultra-fast laser system that produces a train of pulses that in one embodiment are less that 1 ps and in one embodiment is less than 150 fs. A scanner system 12 can be used to scan the laser light rays 14 over an angle preferably in two orthogonal directions. The scanner system 12 can be a variety of technologies including but not limited to t-axis MEM (Micro Electrical Mechanical) scanner, a pair of galvanometer scanners, a pair of galvanometer scanners with relay optics, holographic scanners, acousto-optic scanners, modulated fiber optic scanners, Grating based MEMs (Micro Electrical Mechanical) scanner systems; and light valve based scanners or a variety of other laser bean scanning technologies.

In one embodiment the scanner system 12 can be a 2-axis MEM (Micro Electrical Mechanical) scanner or a pair of galvanometer scanners with relay optics. The optical relay system can be comprised of two or more lenses to relay the light from the output of the scanner to the input of the first focusing lens. The optical relay system has two elements in the figure, first relay optic 28 and second relay optic 30. A minimal number of thin lens elements are preferable to minimize the impact of dispersion introduced by the thickness of the optical materials. The lenses in the optical relay can be of any form including spherical, aspheric, holographic or binary lenses. A minimal number of spherical lenses are preferable due to the reduced fabrication cost normally associated with spherical lenses.

The laser excitation light is reflected off of an optional dichroic beam splitter 32 used to separate the excitation and signal light. In the reflective configuration, the dichroic beam splitter 32 can be highly reflecting at the excitation laser wavelength and highly transparent at the signal wavelength. The reflective configuration is one of several possible configurations of the dichroic beam splitter 32. The dichroic beam splitter 32 can be a dielectric, holographic or grating based beam splitter. The first focusing lens 16 consist of one or more aspheric lenses where the combination of the optical relay lenses and the aspheric lenses produce a scanned laser spot with a curved image field 20 while maintaining a high Strehl Ratio over a wide field of view. The first focusing lens 16 is schematically shown as a single aspheric lens. The aspheric lenses can be formed using molded glass lens technology. The first focusing lens can also incorporate one or holographic or binary surfaces.

Minimizing the overall thickness of the lenses is desirable to minimize the impact of dispersion introduced by the thickness of the optical materials. The radius of the curved image field 20 can change as a function of focus depth within the sample. A detection system can consist of a first collecting optic 34, a filter 36, a second collecting optic 38, and detector 24. The first collecting optic 34 collimates the signal light and the second collecting optic 38 focus the signal light into the detector. The filter 36 allows a range of wavelengths in the signal light to be detected while typically rejecting unwanted laser light. The detector 24 measures the emitted signal light 22 from the sample. The detection system is shown as a single channel thus no additional dichroic beamsplitters are shown.

Because the emitted signal light 22 is no longer affected by the dispersion effect due to optical material thicknesses, a wide range of optical configurations can be used to collect the light. The signal light can be split into two or more channels by the use of dichroic beamsplitters and beamsplitters to determine the spectral content of the signal. Other technologies can be used to split the signal into different spectral components including gratings, holographic gratings, tunable liquid crystal filters and other wavelength selecting technologies. In one embodiment, the detector 24 has high sensitivity including but not limited to photo-multiplier tubes, silicon detectors, avalanche photo detectors and the like.

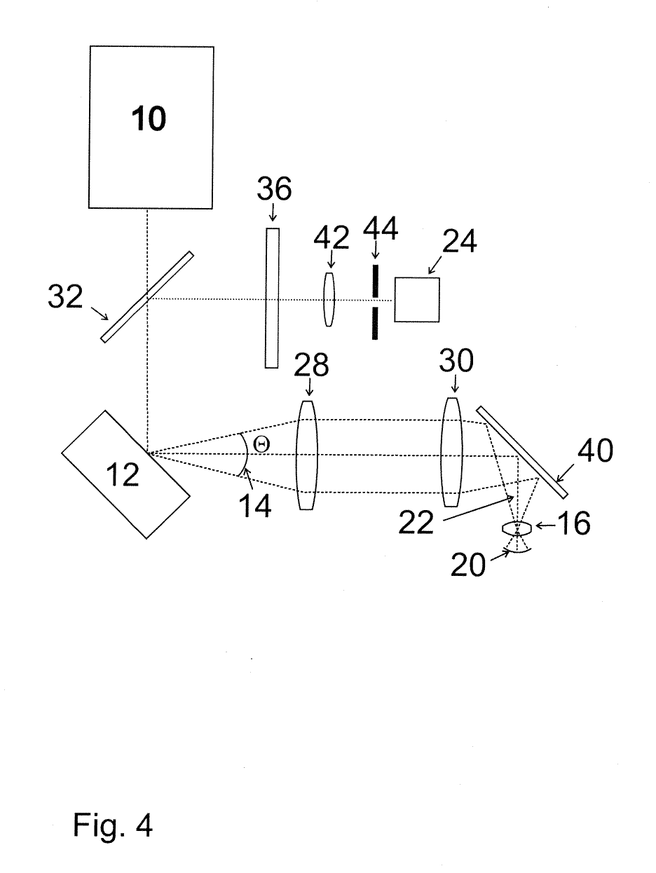

FIG. 4 schematically illustrates a microscopic imaging system operating in confocal mode according to the present invention. The system of the present invention can be comprised of a laser source 10 can be a continuous wave or modulated laser source. A scanner system 12 can be used to scan the laser light rays 14 over an angle Θ preferably in two orthogonal directions. The scanner system 12 can be a variety of technologies including but not limited to t-axis MEM (Micro Electrical Mechanical) scanner, a pair of galvanometer scanners, a pair of galvanometer scanners with relay optics, holographic scanners, acousto-optic scanners, modulated fiber optic scanners, Grating based MEMs (Micro Electrical Mechanical) scanner systems; and Light Valve based scanners or a variety of other laser bean scanning technologies. The scanner system 12 can be a 2-axis MEM (Micro Electrical Mechanical) scanner or a pair of galvanometer scanners with relay optics. The optical relay system can be comprised of two or more lenses to relay the light from the output of the scanner to the input of the first focusing lens lens. The optical relay system has two elements in Figure first relay optic 28 and second relay optic 30.

A minimal number of thin lens elements are preferable to minimize cost and complexity of the system of the present invention. The lenses in the optical relay can be of any form including spherical, aspheric, holographic or binary lenses. A minimal number of spherical lenses are preferable due to the reduced fabrication cost normally associated with spherical lenses. The laser excitation light is reflected off of an optional mirror 40 to the first focusing lens 16. The first focusing lens 16 consist of one or more aspheric lenses where the combination of the optical relay lenses and the aspheric lenses produce a scanned laser spot with a curved image field 20 while maintaining a high Strehl Ratio over a wide field of view. The first focusing lens 16 is schematically shown as a single aspheric lens. The aspheric lenses can be formed using molded glass lens technology.

The first focusing lens 16 can also incorporate one or holographic or binary surfaces. Minimizing the overall thickness of the lenses is desirable to minimize the impact of dispersion introduced by the thickness of the optical materials. The radius of the curved image field 20 can change as a function of focus depth within the sample. The emitted signal light 22 for a confocal imaging system can be collected the first focusing lens 16 and routed back through the first relay optic 28 and second relay optic 30 off the scanner 12 to dichroic beam splitter 32 through a filter 36 to a second focusing lens 42 to a spatial filter 44 to a detector 24. The signal light is reflected off of the dichroic beam splitter 32 used to separate the excitation and signal light. In the signal reflective configuration, the dichroic beam splitter 32 can be highly transparent at the excitation laser wavelength and highly reflecting at the signal wavelength.

The reflective configuration is one of several possible configurations of the dichroic beam splitter 32. The dichroic beam splitter 32 can be a dielectric, holographic or grating based beam splitter. The detection system is shown as a single channel thus no additional dichroic beamsplitters are shown. The signal light can be split into two or more channels by the use of dichroic beamsplitters and beamsplitters to determine the spectral content of the signal. Other technologies can be used to split the signal into different spectral components including gratings, holographic gratings, tunable liquid crystal filters and other wavelength selecting technologies. The detector 24 can be detectors with high sensitivity including but not limited to photo-multiplier tubes, silicon detectors, and avalanche photo detectors.

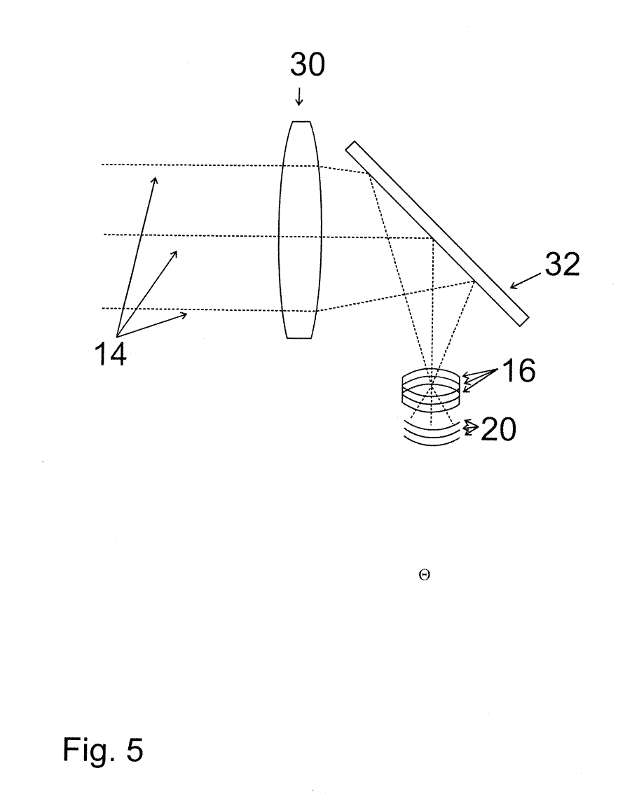

FIG. 5 schematically illustrates a detail of the curved image field 20 according to the present invention. The laser light rays 14 travels through the second relay optic 30, off the dichroic beam splitter 32 and to the first focusing lens 16. By adjusting the focus depth by moving the first focusing lens 16, the location of the curved image field 20 moves within the sample, and different curved surfaces of signal data can be collected. The data from the multiplicity of curved surfaces can be transformed into Cartesian coordinates through the use of mathematical mapping techniques including not limited to matrix transformations. The mathematical mapping techniques use information about the field curvature as a function of depth within the sample based on the optical models or measured performance of the optical system.

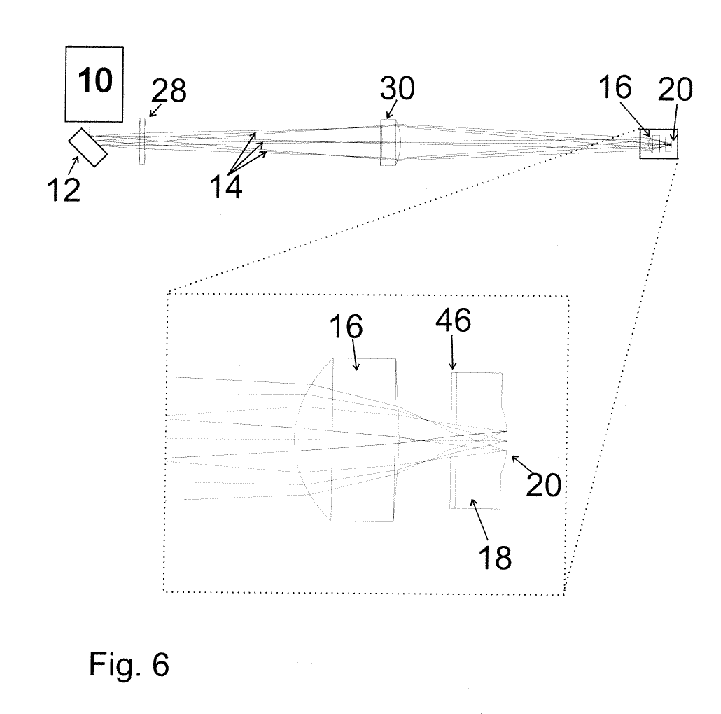

FIG. 6 illustrates the detail of an example optical system using a spherical shaped first relay optic 28 and a spherical shaped second relay optic 30 and a single aspheric shaped first focusing lens 16 according to the present invention. While the example presented used exact specifications for distances, radius of curvatures, aspheric coefficients, and optical materials, the example does not limit the form, shapes, distances, and materials of other equivalent optical systems in one embodiment of the present invention.

The output of a laser source 10 is located 5.0 mm from the scanner system 12. The scanner system 12 scans the laser light rays 14 over +/−5 degrees. The laser light rays 14 are shown as a bundle of three rays in the figure with an initial diameter of 2.5 mm. From the scanner, the laser beam travels 12.0 mm to the first relay optic 28. The first relay optic 28 has a 73.73 mm convex radius of curvature on the first surface and a 42.35 convex radius of curvature on the second surface with a thickness of 2.0 between the surfaces and is constructed from BK7 glass.

From the first relay optic 28, the laser beam travels 63.35 mm to the second relay optic 30. The second relay optic 30 has a 52.70 mm concave radius of curvature on the first surface and a 15.5 convex radius of curvature on the second surface with a thickness of 5.0 between the surfaces and is constructed from BK7 glass. From the second relay optic 30, the laser beam travels 66.65 mm to the 7 first focusing lens. The dichroic beam splitter and detection system are not shown for clarity, and since the dichroic splitter can be typically flat, the location can be anywhere between the second relay optic 30 and the first focusing lens 16.

The first focusing lens 16 has a surface curvature defined by

$$z ( r ) = \frac{{r}^{2}}{R ( 1 + \sqrt{1 - ( 1 + κ ) \frac{{r}^{2}}{{R}^{2}}} )} + {α}_{1} {r}^{2} + {α}_{2} {r}^{4} + {α}_{3} {r}^{6} + … ,$$

Where z(r) is the surface sag along the optical axis, r is the radius from the optical axis, R is the radius of curvature of the surface, κ is the conic constant, and α1, α2, α3 . . . are the aspheric coefficients. Table 1 illustrates a table of the radius of curvature and aspheric coefficients for the first and second surfaces of the first focusing lens 16. The first focusing lens 16 is 3.06 mm thick and is constructed from ECO550M (Lightpath Technologies Inc) glass.

TABLE 1
Radius of curvature and aspheric coefficients for first focusing lens
16 in FIG. 6

| | | |
|---|---|---|
| R, Radius of Curvature | 2.86 | −12.58 |
| κ, conic constant | −4.34E−01 | 0.00E+00 |
| α2 | −6.37E−04 | 4.28E−03 |
| α3 | −2.63E−05 | −1.57E−04 |
| α4 | −1.18E−06 | 4.51E−06 |
| α5 | 7.28E−08 | −8.71E−08 |

The laser beam travels from the first focusing lens 16 a distance of 1.52 mm to a 0.15 mm thick coverglass 46. The beam then travels to the curved image field 20 located 1.5 mm from the coverglass 46. The interior of the sample cell 18 is water in this example. The radius of curvature of the curved image field 20 is a concave 2.85 mm. The Strehl Ratio of the focused laser beam is >0.8 over a 0.6 mm diameter with a numerical aperture of 0.3.

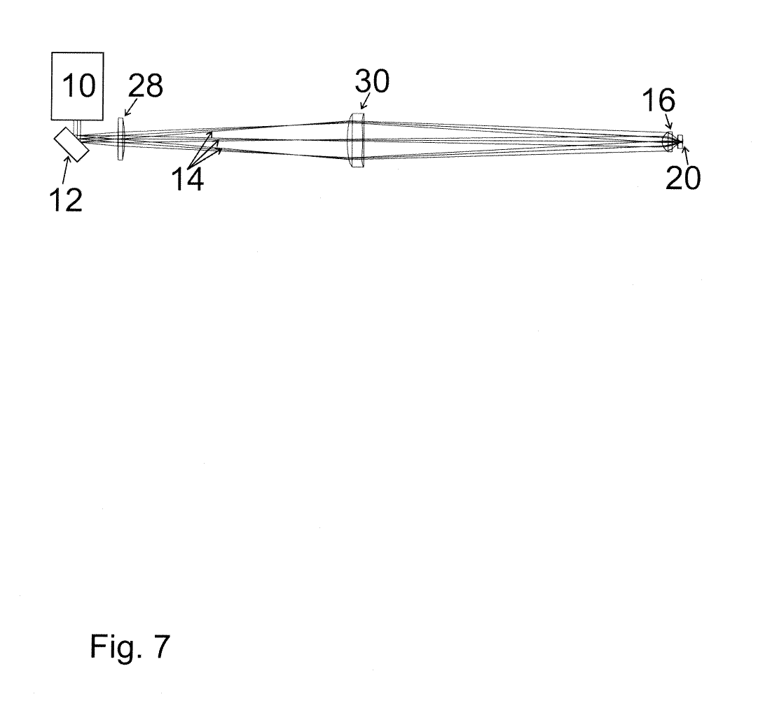

FIG. 7 illustrates the detail of an example optical system using a spherical first relay optic 28 and an aspheric shaped second relay optic 30 and a single aspheric first focusing lens 16 according to the present invention. While the example presented used exact specifications for distances, radius of curvatures, aspheric coefficients, and optical materials, the example does not limit the form, shapes, distances, and materials of other equivalent optical systems covered according to the present invention.

The output of a laser source 10 is located 5.0 mm from the scanner system 12. The scanner system 12 scans the laser light rays 14 over +/−5 degrees. The laser light rays 14 are shown as a bundle of three rays in the figure with an initial diameter of 2.5 mm. From the scanner, the laser beam travels 12.0 mm to the first relay optic 28. The first relay optic 28 has a 170.1 mm convex radius of curvature on the first surface and a 30.67 convex radius of curvature on the second surface with a thickness of 2.01 between the surfaces and is constructed from BK7 glass. From the first relay optic 28, the laser beam travels 65.87 mm to an aspheric shaped second relay optic 30. The aspheric shaped second relay optic 30 has a aspheric surface profile with values listed in table 2. The aspheric shaped second relay optic 30 is 3.06 mm thick and is constructed from BK7 glass.

TABLE 2
Radius of curvature and aspheric coefficients for the an aspheric shaped
second relay optic 30 in FIG. 7

| | | |
|---|---|---|
| R, Radius of Curvature | 53.39 | −81.70 |
| κ, conic constant | −4.34E−01 | 0 |
| α2 | 1.51E−04 | −5.28E−05 |
| α3 | −1.13E−06 | 4.24E−06 |
| α4 | 5.13E−08 | −2.63E−08 |
| α5 | −3.14E−10 | 3.28E−10 |

From the aspheric shaped second relay optic 30, the laser beam travels 88.77 mm to the first focusing lens 16. The dichroic beam splitter and detection system are not shown for clarity, and since the dichroic splitter can be typically flat, the location can be anywhere between the second relay optic 30 and the first focusing lens 16. The first focusing lens 16 has a has a aspheric surface profile with values listed in table 3. The first focusing lens 16 is 3.06 mm thick and can be constructed from ECO550M (Lightpath Technologies Inc) glass.

TABLE 3
Radius of curvature and aspheric coefficients for first focusing
lens 16 in FIG. 7

| | | |
|---|---|---|
| R, Radius of Curvature | 2.87 | −12.56 |
| κ, conic constant | 0 | 0 |
| α2 | −5.55E−04 | 4.68E−03 |
| α3 | −1.30E−05 | −1.90E−04 |
| α4 | −2.20E−08 | −1.10E−05 |
| α5 | −2.71E−07 | 1.45E−06 |

The laser beam travels from the first focusing lens 16 a distance of 1.52 mm to a 0.15 mm thick coverglass 46. The beam then travels to the curved image field 20 located 1.46 mm from the coverglass 46. The interior of the sample cell 18 is water in this example. The radius of curvature of the curved image field 20 is a concave 2.66 mm. The Strehl Ratio of the focused laser beam is >0.8 over a 0.6 mm diameter with a numerical aperture of 0.5. The small number of elements results in a low GVD of 582 fs2 in the optical system. The small GVD stretches a typical 100 fs laser pulse to 101.3 fs.

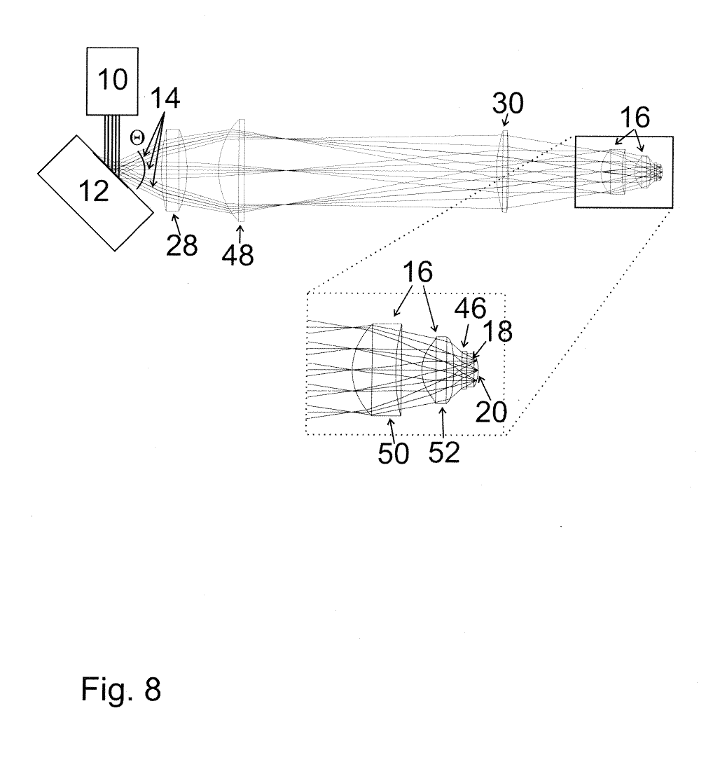

FIG. 8 illustrates the detail of an example optical system using a spherical shaped first relay optic 28 a spherical shaped third relay optic 48 located adjacent to the first relay optic 28 and an spherical shaped second relay optic 30 and a two element aspheric first focusing lens 16 according to the present invention. The figure includes an inset detail of the area around the first focusing lens 16. While the example presented used exact specifications for distances, radius of curvatures, aspheric coefficients, and optical materials, the example does not limit the form, shapes, distances, and materials of other equivalent optical systems covered according to the present invention.

The output of a laser source 10 can be located 10.0 mm from the scanner system 12. The scanner system 12 scans the laser light rays 14 over +/−26 degrees. The laser light rays 14 are shown as a bundle of live rays in the figure with an initial diameter of 3.06 mm. From the scanner, the laser beam travels 9.74 mm to the 3 first relay optic. The first relay optic 28 has a 34.49 mm convex radius of curvature on the first surface and a 20.90 convex radius of curvature on the second surface with a thickness of 5.0 between the surfaces and can be constructed from BK7 glass. From the first relay optic 28, the laser beam travels 6.14 mm to the third relay optic 48.

The spherically shaped third relay optic 48 has a 14.72 mm convex radius of curvature on the first surface and a flat second surface with a thickness of 5.0 between the surfaces and can be constructed from BK7 glass. From the third relay optic 48, the laser beam travels 49.05 mm to the second relay optic 30. The spherically shaped second relay optic 30 has a 26.67 mm convex radius of curvature on the first surface and a 90.27 mm convex radius of curvature on the second surface with a thickness of 2.4 mm between the surfaces and can be constructed from BK7 glass. From the second relay optic 30, the laser beam travels 17.9 mm to the first focusing lens 16. The dichroic beam splitter and detection system are not shown for clarity, and since the dichroic splitter can be typically flat, the location can be anywhere between the second relay optic 30 and the first focusing lens 16. The first focusing lens 16 can be comprised of two aspheric elements a first aspheric focusing lens 50 and a second aspheric focusing lens 52.

The first aspheric focusing lens 50 has an aspheric surface profile with values listed in table 4. The first aspheric focusing lens 50 is 4.15 mm thick and is constructed from acrylic plastic.

TABLE 4
Radius of curvature and aspheric coefficients for the first aspheric
focusing lens 50 in FIG. 8

| | | |
|---|---|---|
| R, Radius of Curvature | 5.71 | 19.87 |
| κ, conic constant | −0.0752 | 0 |
| α2 | −1.87E−04 | 2.68E−04 |
| α3 | −3.74E−06 | −3.28E−06 |
| α4 | −1.06E−07 | 1.41E−07 |
| α5 | −5.14E−09 | 9.28E−11 |
| α6 | −3.37E−10 | −6.52E−09 |
| α7 | −8.14E−12 | 9.60E−11 |
| α8 | 4.89E−13 | 1.01E−11 |

From the first aspheric focusing lens 50, the laser beam travels 2.49 mm to second aspheric focusing lens 52. The second aspheric focusing lens 52 has a has a aspheric surface profile with values listed in table 5. The second aspheric focusing lens 52 is 3.03 mm thick and is constructed from acrylic plastic.

TABLE 5
Radius of curvature and aspheric coefficients for second aspheric
focusing lens 52 in FIG. 8

| | | |
|---|---|---|
| R, Radius of Curvature | 5.71 | 19.87 |
| κ, conic constant | −0.0752 | 0 |
| α2 | −1.87E−04 | 2.68E−04 |
| α3 | −3.74E−06 | −3.28E−06 |
| α4 | −1.06E−07 | 1.41E−07 |
| α5 | −5.14E−09 | 9.28E−11 |
| α6 | −3.37E−10 | −6.52E−09 |
| α7 | −8.14E−12 | 9.60E−11 |
| α8 | 4.89E−13 | 1.01E−11 |

The laser beam travels from the second aspheric focusing lens 52 a distance of 0.8 mm to a 0.45 mm thick coverglass 46. The beam then travels to the 20 curved image field located 1.1 mm from the coverglass 46. The interior of the sample cell 18 is water in this example. The radius of curvature of the curved image field 20 is a concave 3.53 mm. The Strehl Ratio of the focused laser beam is >0.8 over a 2.0 mm diameter with a numerical aperture of 0.63. The small number of elements results in a low GVD of 1320 fs2 in the optical system. The small GVD stretches a typical 100 fs laser pulse to 106.5 fs.

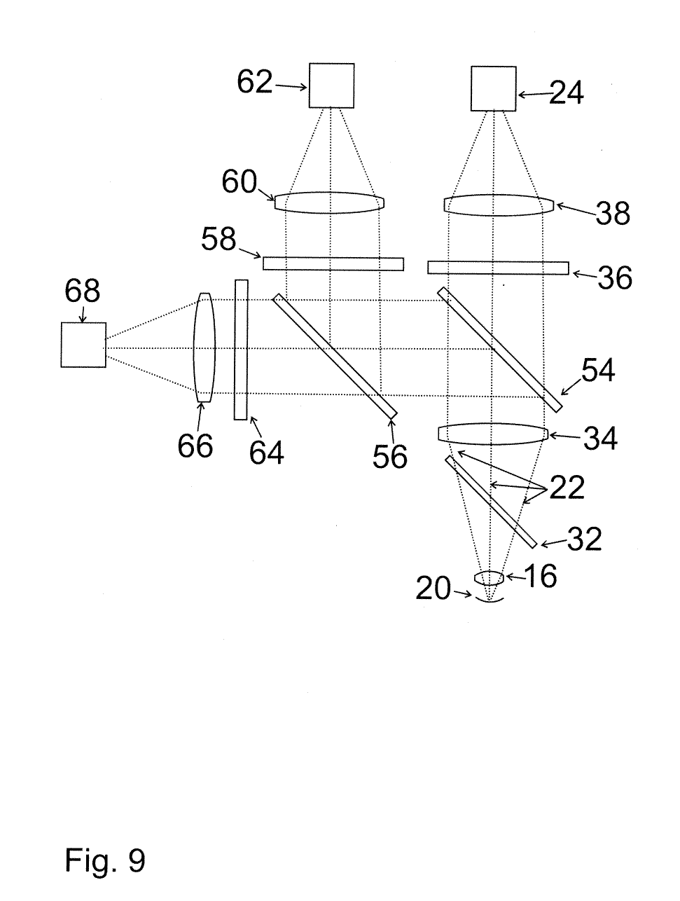

FIG. 9 illustrates a multi channel detection system of the present invention integrated with the microscopic imaging system operating in multiphoton mode according to the present invention. The emitted signal light 22 from the curved image field 20 travels through the first focusing lens 16 though the dichroic beam splitter 32 to the first collecting optic 34 that collimates the signal light. The signal light is then split into separate spectral components by the second dichroic filter 54. One portion of the signal light is transmitted through the second dichroic filter 54 and passes through the first filter 36 to the second collecting optic 38 second collection optic that focuses the light into the detector 24. The other portion of the signal light is again split into separate spectral components by the third dichroic filter 56.

The first spilt portion of the signal light is reflected by the third dichroic filter 56 and passes through the second filter 58 to the third collection optic 60 that focuses the light into the second detector 62. The other split portion of the signal light is transmitted by the third dichroic filter 56 and passes through the third filter 64 to the fourth collection optic 66 that focuses the light into the third detector 68. While the arrangement of filters presented in the figure represents a typical solution to a multi channel detection system, the example does not limit equivalent arrangements of dichroic filter, filters, prisms, gratings, spectrometers and/or lenses that function as multichannel optical systems covered according to the present invention.

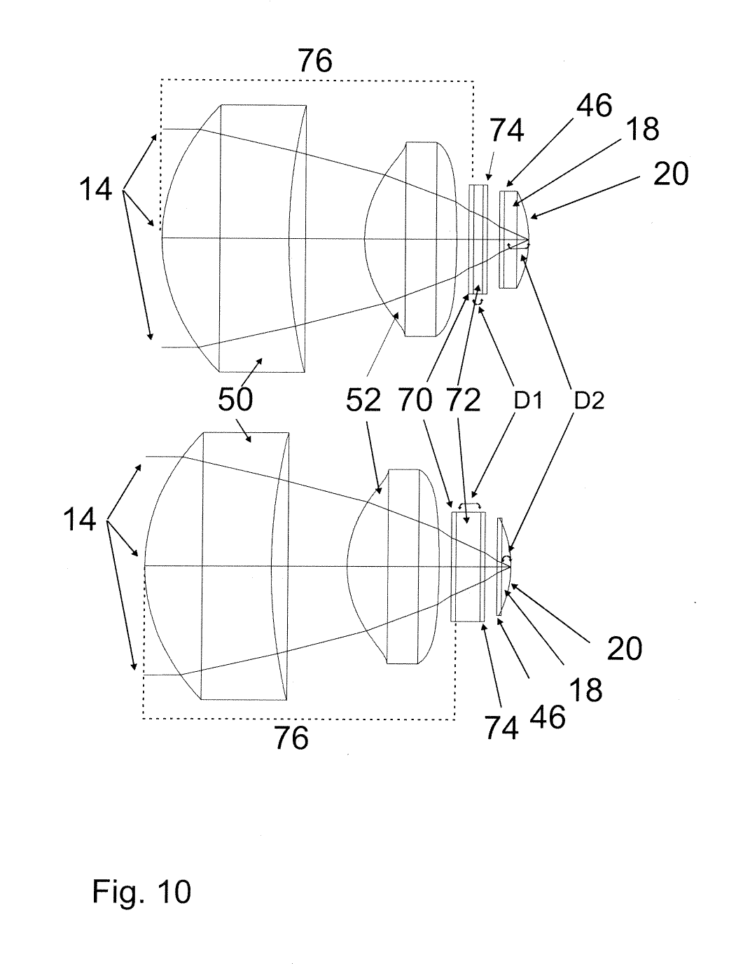

FIG. 10 illustrates a variable thickness cell focus compensation system according to the present invention. The laser light rays 14 travels through the first aspheric focusing lens 50 and a second aspheric focusing lens 52 to the variable thickness cell focus compensation system. The variable thickness cell focus compensation system can be comprised of a first focus compensation cell surface 70, a focus compensation medium 72 and a second focus compensation cell surface 74.

The first focus compensation cell surface 70 and the second focus compensation cell surface 74 are can be a thin layer of glass or sapphire. The focus compensation medium 72 can have an index of refraction similar to the index of refraction of the interior of the sample cell 18. The light then passes through the variable thickness cell focus compensation system to the coverglass 46 and into the sample cell 18 and can be focused at the curved image field 20. The focus compensation system motion preserves the sum of the thickness D1 of the focus compensation medium 72 and the thickness D2 of the sample cell 18 to the curved image field 20.

As the thickness D1 is increased the depth of focus D2 decreases. As the thickness D1 is decreased the depth of focus D2 increases. By preserving the optical path length through all the optical elements, a high quality focus is maintained as the sample is scanned as a function of depth. The focus compensation can also involve the motion of the lenses within the first focusing lens lenses either separately or together. In one embodiment, a focus compensation system forms a focus compensation system group 76 comprised of the first aspheric focusing lens 50, second aspheric focusing lens 52 and the first focus compensation cell surface 70 and where the focus compensation system group 76 elements move together and the sample container remains stationary. The example presented here does not limit equivalent arrangements of variable distance structures including but not limited to sliding glass or plastic wedges.

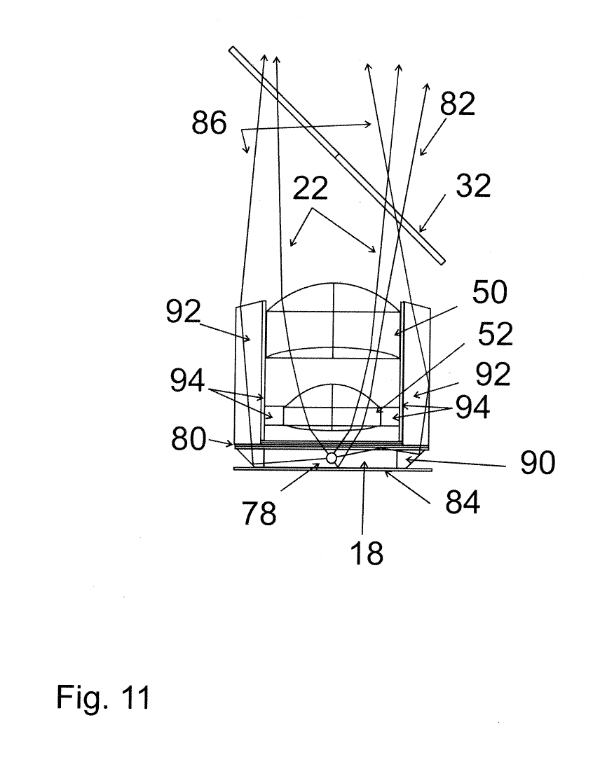

FIG. 11 illustrates a sample chamber with integrated reflective optics together with a hollow waveguide according to the present invention. As the excitation laser light interacts with a sample 78 within the interior of the sample cell 18, the signal from the sample in the multiphoton imaging mode is emitted in all directions. A portion of the emitted signal light 92 travels back though focus compensation system 80, the second aspheric focusing lens 52 the first aspheric focusing lens 50 and the dichroic beam splitter 32 to the detection optics. Another portion of the emitted signal light rays 82 travel in the opposite direction from the compact object lens towards the bottom of the sample cell 84.

By adding a reflective material on the bottom of the sample cell 84, this light can be directed towards the second aspheric focusing lens 52 to the first aspheric focusing lens 50 and to the dichroic beam splitter 32 to the detection optics. Another portion of the emitted signal light rays 86 travels out to the sides. The emitted signal light rays 86 travel out to the sides of the sample cell to a reflective prism structure 90. The emitted signal light rays 86 are reflected in the direction of the detection optics by the reflective prism structure 90 that surrounds the sample 78 and interior of the sample cell 18. The reflection can either occur by a reflective metal or dielectric material or in a one embodiment; the reflection is due to total internal reflection off the hypotenuse of the reflective prism structure 90. The emitted signal light rays 86 travel through a waveguide 92 that surrounds the first aspheric focusing lens 50 and second aspheric focusing lens 52. The emitted signal light rays 86 travel to the dichroic beam splitter 32 to the detection optics. The system of the present invention may incorporate lens mounting structures 94 to hold the first aspheric focusing lens 50 and second aspheric focusing lens 52 inside the waveguide 92. In one embodiment, the reflective prism can be in a cylindrical shape that completely surrounds the sample 78 and the interior of the sample cell 18 and is matched to a cylindrically shaped waveguide 92. In one embodiment, the reflective prism structure 90 in the sample chamber is molded out of plastic and the reflection is due to total internal reflection off the hypotenuse of the reflective prism structure 90. In one embodiment, fluids are flowed through the sample cell 18 via connecting ports to the sample cell 18.

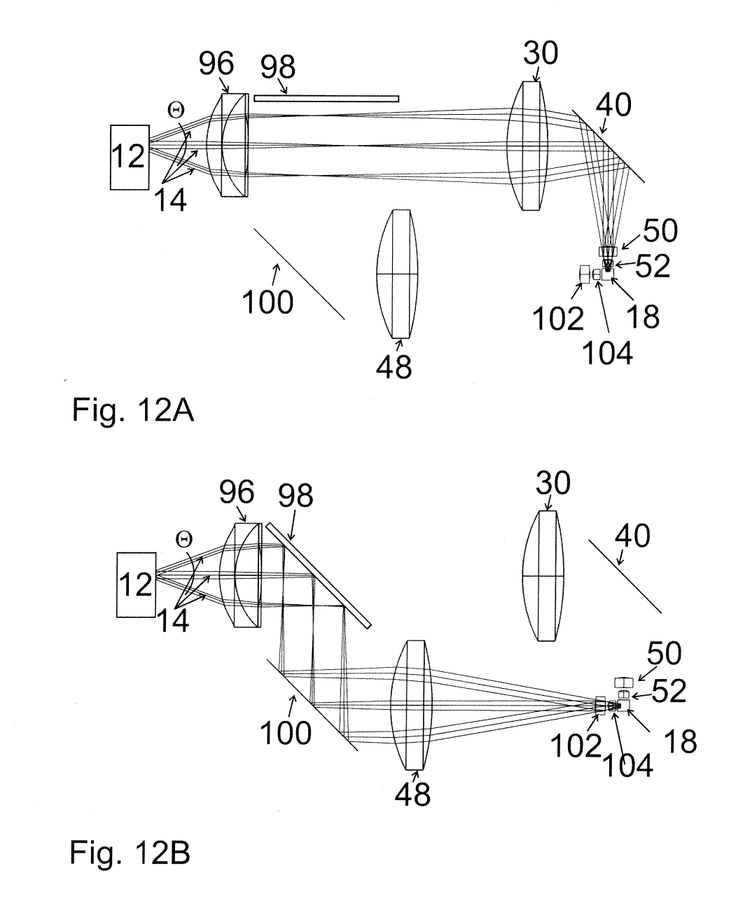

FIGS. 12(a) and 12(b) illustrate an optical arrangement with a movable mirror to image two orthogonal sides of the sample chamber according to the present invention FIG. 12A illustrates one path for the excitation light with FIG. 12B be illustrates a second path of the excitation light.

In FIG. 12(a), the scanner 12 moves the laser light rays 14 over an angle Θ to a achromatic relay optic 96. The achromatic relay optic 96 can be comprised of two different glass types used to improve the correction of optical aberrations. The use of a achromatic relay optic 96 in this example presented here does not limit equivalent arrangements of lens types for the first relay optic. The laser light rays 14 bypasses a movable mirror 98 and travels through the second relay optic 30, to a mirror 40 and is reflected towards the a first focusing lens formed by a first aspheric focusing lens 50 and a second aspheric focusing lens 52. The laser light rays 14 travel through the first aspheric focusing lens 50 and a second aspheric focusing lens 52 to the interior of the sample cell 18.

In FIG. 12(b), the scanner 12 moves the laser light rays 14 over an angle θ to a achromatic relay optic 96. The laser light rays 14 reflect off the movable mirror 98 that is now moved into the beam path. The laser light rays 14 reflect off the second mirror 100 and travel through the third relay optic 48 towards a first focusing lens formed by a third aspheric focusing lens 102 and a fourth aspheric focusing lens 104. The third relay optic 48 can be generally equivalent in function and form to the second relay optic 30. The laser light rays 14 travel through the third aspheric objective lens 102 and a fourth aspheric objective lens 104 to the interior of the sample cell 18. The third aspheric focusing lens 102 and fourth aspheric focusing lens 10 are generally equivalent in function and form to the first aspheric focusing lens 50 and a second aspheric focusing lens 52.

FIGS. 12(a) and 12(b) show that with the addition of a small number of components imaging for two orthogonal sides can be achieved. While in general the two optical paths can be generally equivalent in function and form as in the example presented here, this does not limit equivalent arrangements of different optical paths that might have different magnifications, resolutions, depths of focus, fields of view, or other optical function differences.

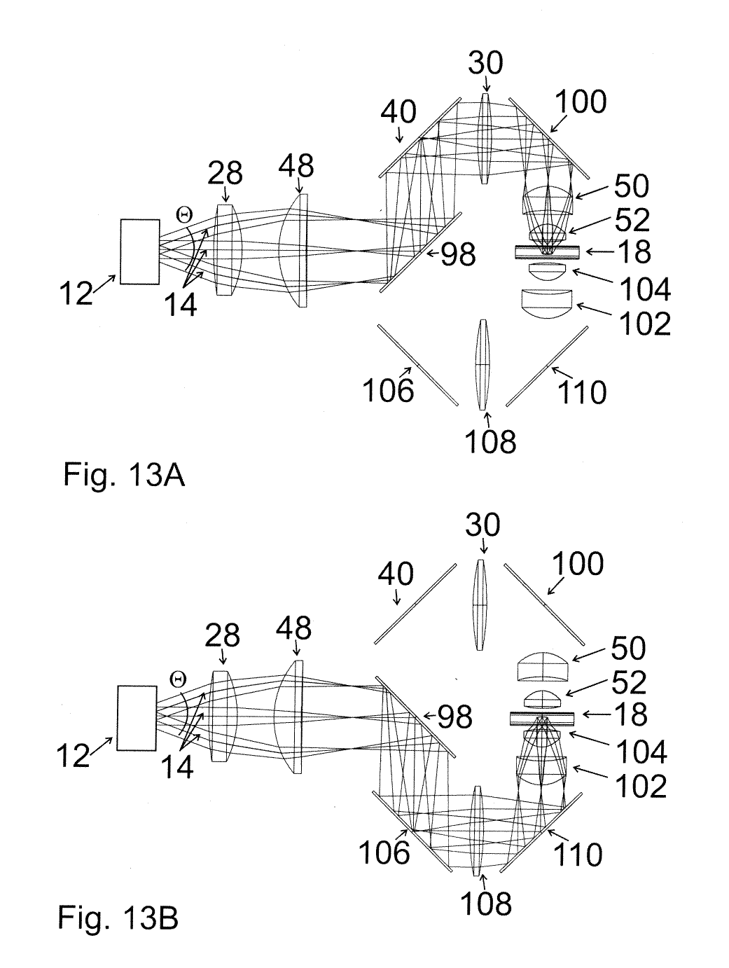

FIGS. 13(a) and 13(b) illustrate an optical arrangement with a movable mirror to image two opposite sides of the sample chamber according to the present invention FIG. 11(a) illustrates one path for the excitation light with FIG. 11(b) illustrates a second path of the excitation light.

In FIG. 13(a), the scanner 12 moves the laser light rays 14 over an angle Θ to a first relay optic 28 and then to a third relay optic 48 third spherical relay optic. The laser light rays 14 reflects off the movable mirror 98 and travels to and is reflected by a mirror 40 and then through the second relay optic 30, to a second mirror 100 and is reflected towards the first focusing lens. The laser light rays 14 travel through the first aspheric focusing lens 50 and a second aspheric focusing lens 52 to the interior of the sample cell 18.

In FIG. 13(b), the scanner 12 moves the laser light rays 14 over an angle Θ to a first relay optic 28 and then to a third relay optic 48 third spherical relay optic. The laser light rays 14 reflect off the movable mirror 98 and travels to and is reflected by a third mirror 106 and then through the fourth relay optic 108, to a fourth mirror 110 and is reflected towards the first focusing lens formed by a third aspheric focusing lens 102 and a fourth aspheric focusing lens 104. The fourth relay optic 108 can be generally equivalent in function and form to the second relay optic 30. The laser light rays 14 travel through the third aspheric objective lens 102 and a fourth aspheric objective lens 104 to the interior of the sample cell 18. The third aspheric focusing lens 102 and fourth aspheric focusing lens 104 are generally equivalent in function and form to the first aspheric focusing lens 50 and a second aspheric focusing lens 52.

FIGS. 13(a) and 13(b) show that with the addition of a small number of components imaging for two opposing sides can be achieved. While in general the two optical paths can be generally equivalent in function and form as in the example presented here, this does not limit equivalent arrangements of different optical paths that might have different magnifications, resolutions, depths of focus, fields of view, or other optical function differences.

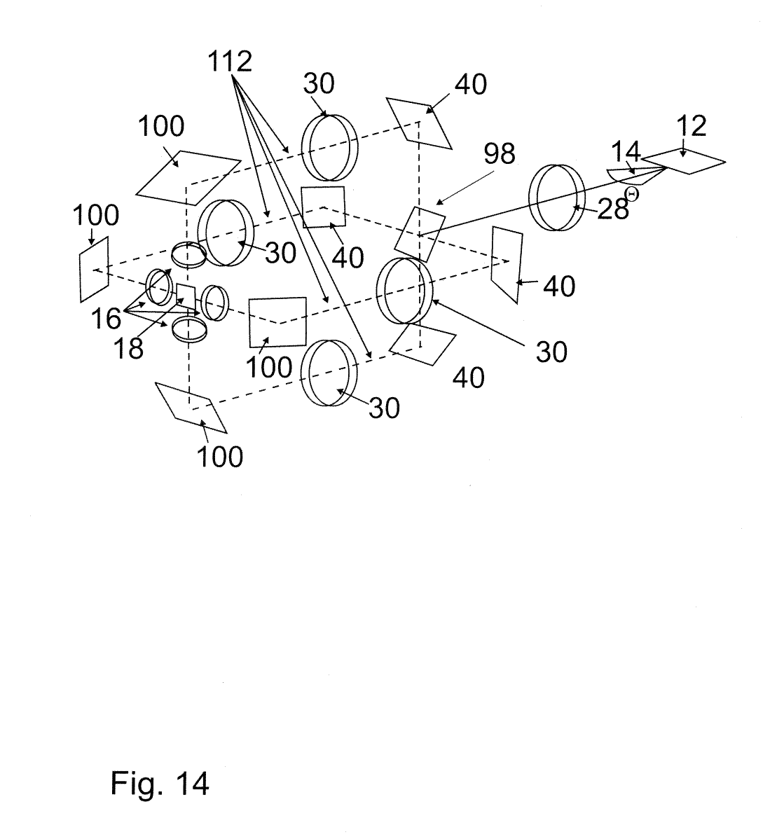

FIG. 14 illustrates an optical arrangement with a movable mirror to image form four sides of the sample chamber according to the present invention The scanner 12 moves the laser light rays 14 over an angle Θ to a first relay optic 28. The laser light rays 14 reflect off the movable mirror 98. The movable mirror 98 moves as to direct the laser light rays 14 down four different optical paths 110. Along each optical path, the laser light rays 14 travel to and is reflected by a mirror 40 and then through the second relay optic 30, to a second mirror 100 and is reflected towards the first focusing lens 16 and to the interior of the sample cell 18.

The FIG. 14 embodiment illustrates that with the addition of a small number of components imaging for multiple sides can be achieved. In one embodiment where the movable mirror and the multiple optical paths that allow for imaging from four sides where the pairs of paths image from opposite sides. While four optical paths are presented in this example, the number of potential optical paths can be lesser or greater than four. While in general the multiple optical paths can be generally equivalent in function and form as in the example presented here, this does not limit equivalent arrangements of different optical paths that might have different magnifications, resolutions, depths of focus, fields of view, or other optical function differences.

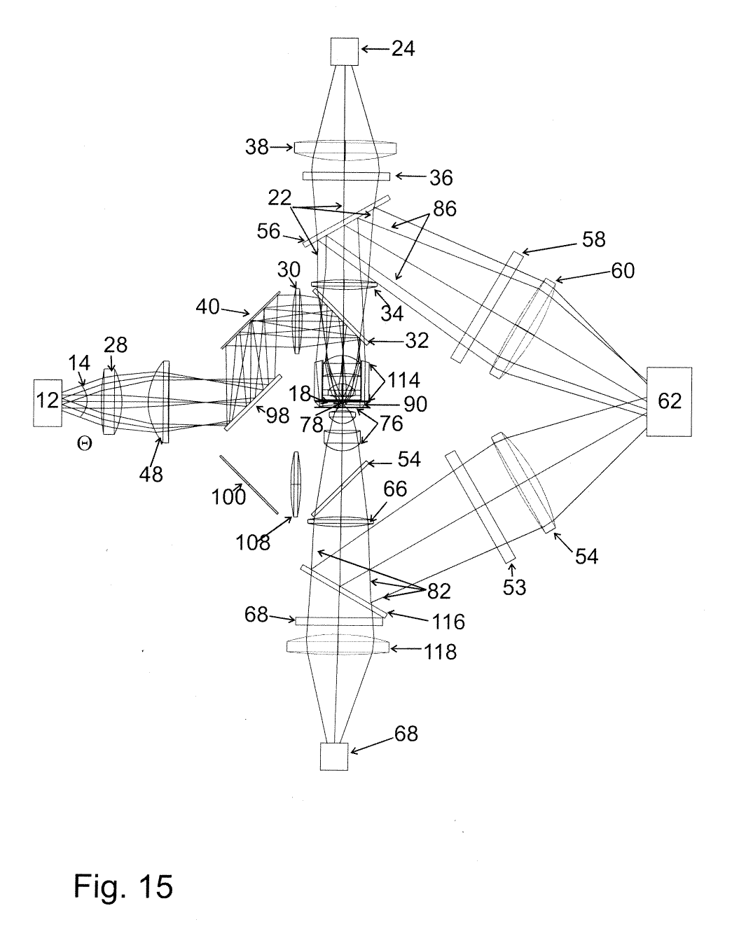

FIG. 15 illustrates a movable mirror imaging two opposing sides of the sample chamber together with an arrangement of detection optics according to the present invention In one embodiment, the two sided imaging system together with collection features in the sample chamber are arranged with a collection of dichroic beam splitters and filters to minimize the number of detectors used within the system of the present invention. The scanner 12 moves the laser light rays 14 over an angle Θ to a first relay optic 28 and then to a third relay optic 48. The laser light rays 14 reflect off the movable mirror 98 and travels to and is reflected by a mirror 40 and then through the second relay optic 30, to a dichroic beam splitter 32 and is reflected towards the a group 112 comprised of a first focusing lens with waveguide and focus compensation system.

The group 114 comprised of a first focusing lens with waveguide and focus compensation system can be comprised of a pair of aspheric objective lens a waveguide and focus compensation system that is detailed in FIG. 11. In one embodiment, the group 114 elements move together and the interior of the sample cell 18 remains stationary. The laser light rays 14 travel through the group 112 comprised of a first focusing lens with waveguide and focus compensation system to the interior of the sample cell 18 and excites the sample 78. A second optical path for the excitation light can be comprised of a second mirror 100, fourth relay optic 108, second dichroic filter 54, and a focus compensation group 76. The focus compensation group 76 can be comprised of a pair of aspheric objective lens and focus compensation system as detailed in FIG. 10.

In one embodiment, the focus compensation group 76 elements move together and the interior of the sample cell 18 remains stationary. Some emitted signal light rays 22 travel back thought the objective elements of the group 112 comprised of a first focusing lens with waveguide and focus compensation system. Other signal light rays 86 travels out to the sides of the sample cell 18 to a reflective prism structure 90 where the light is reflected in the direction of the detection optics by a reflective prism structure 90 that surrounds the sample 78 and the interior of the sample cell 18. The emitted signal light 86 travels through a waveguide contained within the group 112 comprised of a first focusing lens with waveguide and focus compensation system. Both the signal light rays 22 and signal light rays 86 pass through the dichroic beam splitter 32. Other signal light rays 82 travel out another side of the sample cell 18 through the focus compensation group 76 to the second dichroic filter 54. Both the signal light rays 22 and signal light rays 86 are collected by a first collecting optic 34 and then separated into two spectra ranges by the third dichroic filter 56.

One spectral range travels through the third dichroic filter 56 through a filter 36 and to a second collecting optic 38 second collection optic to a first detector 24. The other spectral range is reflected by the third dichroic filter 56, through a second filter 58, to a third collection optic 60 and to a second detector 62. In one embodiment, the reflection angle from the third dichroic filter 56 is less than or equal to 30 degrees. The signal light rays 82 are collected by a fourth collection optic 66 and then separated into two spectra ranges by the fourth dichroic filter 116. One spectral range travels through the fourth dichroic filter 116 through a third filter 64 and to a fifth collection optic 118 to a third detector 68. The other spectral range is reflected by the third dichroic filter 116, through a fourth filter 120, and to a sixth collection optic 122 to a second detector 62. The second detector 62 detects signal light from the top, bottom and sides of the sample cell.

In one embodiment, with a multiphoton imaging mode, the spectral ranges for third dichroic filter 56 and fourth dichroic filter 116 are configured so that the second harmonic generated light travels though the filters, thus the first detector 24 detects the reverse second harmonic generation light and the second detector 68 detects the forward second harmonic generation light when the excitation light can be configured as in FIG. 15. When the movable mirror 98 is moved so that the excitation light is coming from the opposite direction into the sample 78, the first detector 24 detects the forward second harmonic generation light and the second detector 68 detects the reverse second harmonic generation light. While the arrangement of filters presented in the figure represents a solution to a multi channel detection system, the example does not limit equivalent arrangements of dichroic filter, filters, prisms, gratings, spectrometers and/or lenses that function as multichannel optical systems covered according to the present invention. The example can be extrapolated to more complex multi-sided excitation systems where the multi-sided focusing optics together with the collection features in the sample chamber are arranged with a collection of dichroic beam splitters and filters to minimize the number of detectors used within the system of the present invention.

1. A microscopic imaging system, comprising:
a laser source,
a scanner system coupled to the laser source;
a first lens coupled with the scanner system, the first lens producing a scanner laser spot with a curved field that is incident on a tissue site;
a detection system that detects a fluorescence and non-linear light emitted from the tissue site.

2. The system of claim 1, further comprising:
an optical relay system that includes at least two lenses.

3. The system of claim 1, wherein the first lens is an aspheric shaped lens.

4. The system of claim 1, wherein the fluorescence and non-linear light is emitted from the tissue site in a range of 180 degrees relative to a surface of the tissue site that the laser spot with curved field is incident on.

5. The system of claim 1, wherein the fluorescence and non-linear light is emitted from the tissue site in a range of 360 degrees relative to a surface of the tissue site that the laser spot with curved field is incident on.

6. The system of claim 1, wherein the fluorescence and non-linear light is emitted from the tissue site in any detectable direction relative to a surface of the tissue site that the laser spot with curved field is incident on.

7. The system of claim 1, wherein the fluorescence and non-linear light emitted from the tissue site is three-dimensional.

8. The system of claim 3, wherein the first focusing lens generates different curved surfaces of signal data.

9. The system of claim 8, wherein data from a multiplicity of curved surfaces of the tissue site is transformed into Cartesian coordinates.

10. The system of claim 1, wherein the laser source is an ultrafast laser source.

11. The system of claim 1, where the laser source is a continuous-wave laser.

12. The system of claim 1, wherein the laser source is modulated laser.

13. The system of claim 1, wherein the detection system is a confocal detection system.

14. The system of claim 1, further comprising:
a variable thickness cell focus compensation system.

15. The system of claim 1, further comprising:
a sample chamber for receiving tissue of the tissue site with integrated reflective optics and a hollow waveguide.

16. The system of claim 15 further comprising:
a movable mirror to image two or more sides of the sample chamber.

17. The system of claim 16, wherein two orthogonal sides of the sample chamber are imaged.

18. The system of claim 16, where two opposite sides of the sample chamber are imaged.

19. The system of claim 16, wherein the sample chamber includes four interior walls that are imaged from two orthogonal and two opposing directions.

20. The system of claim 16, further comprising:
two or more collection optics associated with multiple sides of the sample chamber and multiple detection systems.

21. The system of claim 16, further comprising:
two or more collection optics associated with multiple sides of the sample chamber that are configured to share multiple detection systems.

22. A method for examining tissue at a tissue site comprising:
producing a beam of light from a laser source;
scanning the beam of light;
producing a scanner laser spot with a curved field that is incident on the tissue site;
detecting a fluorescence and non-linear light emitted from the tissue site.

23. The method of claim 22, wherein in response to detecting the fluorescence and non-linear light emitted from the tissue site detecting a characteristic of the tissue site.

24. The method of claim 22, wherein the fluorescence and non-linear light is emitted from the tissue site in any detectable direction relative to a surface of the tissue site that the laser spot with curved field is incident on.

25. The method of claim 22, wherein the fluorescence and non-linear light emitted from the tissue site is three-dimensional.

26. The method of claim 22, further comprising:
generating different signal data from different curved surfaces
